(19) United States
(12) Patent Application Publication
(10) Pub. No.: US 2011/0155331 A1
(43) Pub. Date: Jun. 30, 2011

(54) Two tone venetian blind for absorbing and reflecting heat

(76) Inventor: Kerry Lopin, Loves Park, IL (US)

(21) Appl. No.: 12/655,443

(22) Filed: Dec. 31, 2009

(51) Int. Cl. E06B 9/28

(52) U.S. Cl. 160/178.1 R; 160/405

(57) ABSTRACT

A dual purpose Venetian blind for assisting in cooling and/or heating an adjacent room by providing slats with one side having a heat absorbing surface and the opposite side having a heat reflecting surface. The blind slats are selectively moveable to present the reflective or absorbing side to the outside and either reflect light and heat or absorb the light and heat. Thus, a room with such a blind can have temperature control assisted by positioning the reflective facing the outside during the summer to reflect heat and the dark side facing out during the winter to absorb heat energy from the sun.

### BACKGROUND OF THE INVENTION

(1) Field of the Invention

This disclosure pertains to a heat absorbing and heat reflecting Venetian blind and method for controlling the temperature in a room with windows by reflecting sunlight from the room in the summer and absorbing sunlight in the winter.

(2) Description of the Prior Art

Many attempts have been made in the past to reduce radiation energy, i.e. sunlight, from entering a room through windows in order to reduce costs of cooling the room with air conditioning. The Leuder, U.S. Pat. No. 3,236,290 (1966) shows arrangements of window coverings that provide reflection of heat away from the room during the summer and retention of heat in the winter by absorbing sunlight entering the room and reflecting heat back into the room. Several layers of metal are applied to the slats of the blinds in a varying thickness to allow light entering the room to be attenuated, that is controlled, while at the same time reflecting sunlight to produce a cooling effect. Such features, while desirable, are quite complicated, as explained requiring the application of a metal coating such as gold, platinum, nickel and copper that have high reflecting power of heat yet will admit some light. The shade disclosed may have different sections of different metal thicknesses to vary the amount of light that enters and may be controlled manually or electronically with the disclosed mechanism and circuit. It is recommended that the space between the shade and window be sealed.

Another prior art patent is the Luboshez, U.S. Pat. No. 2,874,612 (1959) that discloses a translucent, pleated shade with metallic strips painted thereon to reflect heat. The shade provides alternating a reflective and translucent strips to reflect heat energy and may be rolled up to allow light or viewing through the covered window.

The Hyman et al., U.S. Pat. No. 4,049,038 (1977) shows decorative, strips that can be inserted and removed from vertical blinds. The patent discloses one version using highly reflective strips on one side of each vertical strip to reflect sunlight to control room temperature. However, there is no disclosure of providing the opposite side with a heat absorbing color to absorb heat for heating the room by first transmitting solar energy to the room to heat and then retaining the heat via a opposite side surface that reflects heat back into a room.

Yet another prior art patent is the Malone, U.S. Pat. No. 3,645,317 (1972) that shows a Venetian blind with metallic coated reflective slats that allow some sunlight into a room while filtering out the heat. The patent shows that by overlapping the slats a problem at night that prevents the occupant looking out but provides unhindered inward visibility is overcome. This patent does not address the dual approach of summer and winter features that prevents the room from heating up during the summer yet will allow heat to be retained in the winter by merely reversing the position of the slats.

The device shown in the present disclosure, on the contrary, departs from the direction suggested by these patents that show a common Venetian blind having slats with a black or heat absorbing side and a white or heat reflecting side. This combination provides a design that diverges from earlier designs and goes in a totally different direction to solve the same type problem of preventing heat from entering a room during the summer and retaining sunlight heat during the winter.

### SUMMARY OF THE INVENTION

The instant disclosure pertains to a Venetian blind that has slats with a non reflective or heat absorbing side and reflective side. In operation, the blind may have the slats tilted to the outside of a room adjacent a window to reflect sunlight during the summer when it is desirable to keep the adjacent room cool. The slats may be reverse tilted during the winter to face the heat absorbing dark side toward the outside to absorb sunlight and heat the room during the winter. In the winter, with the dark side facing out, the reflective side facing the room, reflects heat back into the room to keep it warm. By reducing the heating and cooling needs energy is conserved and may produce carbon credits for the user.

It is thus a purpose or object of the present invention to provide an improved window covering that has a heat absorbing side and a reflective side.

It is another object of the invention to provide a Venetian blind with slats that have a heat absorbing coating on one side and a heat reflecting coating on the other.

Another object of the invention is to provide an inexpensive window covering that allows a conventional Venetian blind to be easily converted to a thermal conductor to assist in heating a room by covering one side of the slats of the blind with a heat absorbing coating such as black paint.

Yet another object of the invention is to provide a Venetian blind window covering that is slightly open to allow air to pass through the slats and is spaced from an adjacent window to provide a thermal chimney that captures heated air that rises into a room and pulls cooler air from a room for heating during the winter.

It is another object of the present invention to provide a simple Venetian blind with individual slats with a dark, heat absorbing side and a lighter color reflective side that can be made as a two piece unit joined together in the manufacturing process.

Another object of the invention is to disclose a process for converting conventional Venetian blinds into heat absorbing/reflecting blinds by simply coating at least one side of the slats with an appropriate color paint.

Another object of the invention is to disclose a Venetian blind with color slats enhanced with an infra red absorbing additive on one side to reflect and with a second side enhanced to absorb infra red energy.

These and other objects of the invention will become apparent to those having ordinary skill in the art with reference to the following description, drawings and appended claims.

### BRIEF DESCRIPTION OF THE DRAWINGS

FIG. 1 is a segmented elevation view of a typical Venetian blind mounted in a window frame adjacent a window with the left side showing an open position and the right side showing a closed position;

FIG. 2 shows the dark or heat absorbing side of the Venetian blind shown in FIG. 2;

FIG. 3 shows the light or heat reflecting side of the Venetian blind shown in FIG. 2;

FIG. 4 is a partial section view of several slats of a Venetian blind in a slightly open position;

FIG. 5 is similar to FIG. 4 and is a partial section view of several slats of a Venetian blind in a closed position;

FIG. 6 is an enlarged partial view of a slat showing the heat absorbing or dark side;

FIG. 7 is an enlarged partial view of a slat showing the heat reflective or light color side;

FIG. 8 is a graph of the summer heat level entering a window and lowering as it is reflected by the blind disclosed herein; and,

FIG. 9 is a graph of the winter heat level entering a window and being absorbed and slightly lowering as it is absorbed by the blind disclosed herein.

### DESCRIPTION OF THE PREFERRED EMBODIMENTS

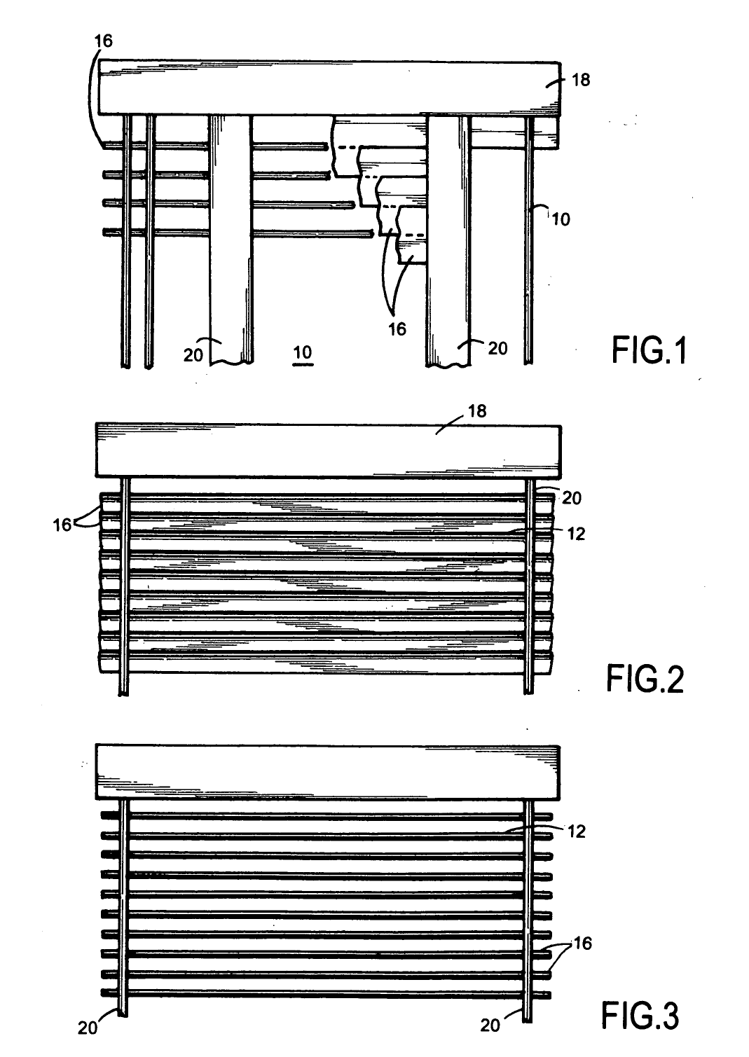

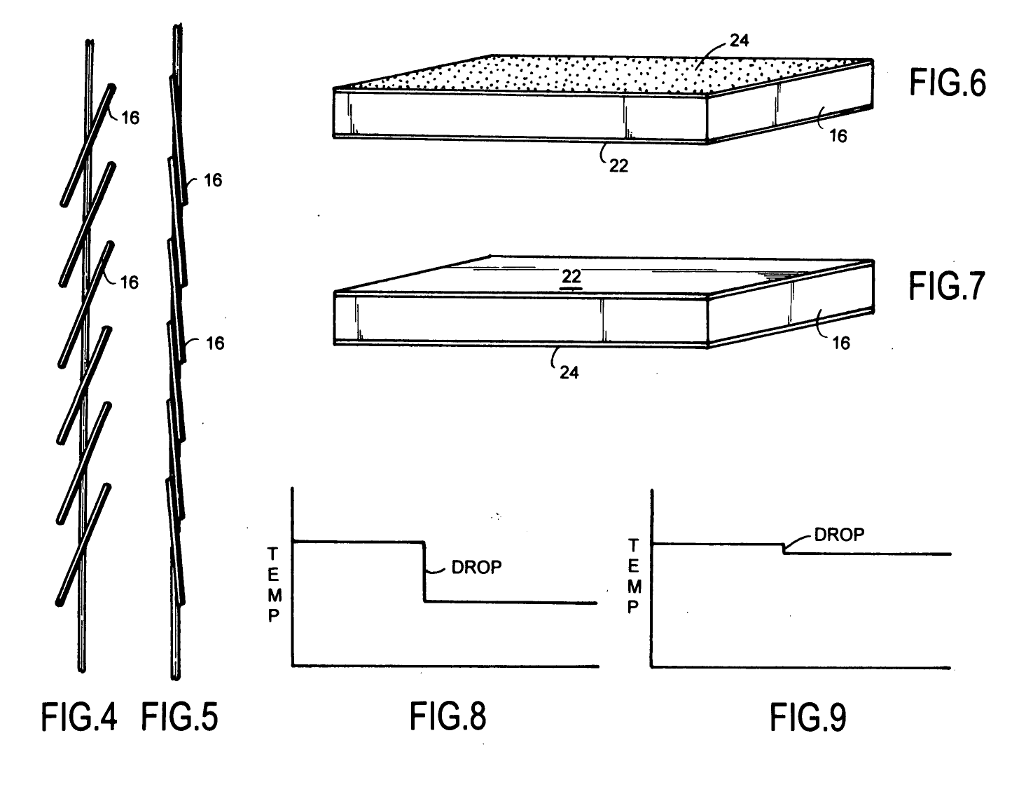

Referring now to the drawings and in particular FIGS. 1-3 there is shown a typical window 10 with a Venetian blind 12 mounted therein to be used to admit or shut out light and the accompanying sunlight as well as provide privacy. In a customary installation the blind 12 is mounted adjacent but spaced from the window 10. The blind 12 has a number of slats that extend essentially the full width of the window 10 and are adjustable from a fully closed to a fully open position with the slats 16 positioned horizontally as shown in FIG. 1 to admit outside light. As understood, the blinds can be moved into a closed position to keep out light or for privacy as shown in FIG. 1 with either side of the slats 16 facing in or out of the room.

As shown in FIG. 6, 7 each slat 16 has a coating on each side. Coating 22 is light in color and is intended to reflect light. Paint or a natural light color plastic could be used to provide the reflective side of the slat. The opposite side has a dark of heat absorbing color indicated by the numeral 24. Again it is contemplated that a flat, non reflective black paint or other coating such as a thin film or inherent dark color in a plastic slat for example could be used and the separate step of painting the slat 16 could be avoided for primary manufacturing and sale. Another feature of this invention is that it can be used to convert the millions or single color blinds now in use to the summer/reflecting and winter/absorbing style for energy efficience and comfort as disclosed herein.

Single color blinds now in use throughout the world could be converted by applying a very dark and dull paint to one side of the slats of conventional blinds. If the second or opposite side is a light reflective color no painting or color lighting is needed. If the reverse color scheme is present, i.e. the slats are dark, then the opposite side need be colored a light, reflective color, preferably by painting.

Painting is recommended since it is widely available, requires no specific skill, and is economical. It is recommended that a reflective paint be a glossy variety and a very light or white color. Similarly, the dark side should be painted with a flat, non glossy paint to not reflect but absorb light and heat. A reflective paint that is recommended for plastic slats is Sherman Williams Duration or Resilience exterior acrylic latex flat white paint. This paint has the feature of reducing heat absorption and will enhance the performance of the coated, reflective slat. These lines of paint will also allow use of a darker color without significantly reducing light and hear reflection. An absorbing paint that is recommended for plastic, wood or metal slats is Sherwin Williams Duration or Super lines of black paint. These paints are recommended after the slats have been cleaned for proper adhesion of the paint. These paints can also be used on wood slats needing color change.

Slat 16 could be a composite of two thin pieces, one a dark color to absorb light and the other a light color to reflect light. Such a product could be made easily and economically with automatic manufacturing equipment.

It can be seen from the foregoing that a simple, economical and effective method of keeping out heat in the summer and keeping in heat in the winter has been disclosed. Heat absorbing/reflecting Venetian blinds can be produced easily or converted from existing blinds to provide the cooling and heat absorbing features.

By using the two tone Venetian blind of the present invention the heating and cooling needs of a room are reduced. Such a reduction produces an energy savings and thus reduces the so-called carbon footprint of a structure. This reduction in turn produces a desired effect on the environment by reducing hot house gasses that are connected with global warming and a reduction in the ozone layer.

The forgoing description and drawings merely explain and illustrate the invention and the invention is not limited thereto, except insofar as the appended claims are so limited, as those who are skilled in the art and have the disclosure before them will be able to make modifications without departing from the scope of the invention.

What is claimed is:

1. A dual purpose Venetian blind for assisting in cooling or heating an adjacent room by providing heat reflection and heat absorption and comprising a plurality of aligned and stackable blind slats having two sides comprising a top and bottom and said Venetian blind having mounting means for attaching adjacent a window and having operating means with connecting members adapted to rotate said blind slats about their length between opened and closed positions thereby moving the top and bottom between first and second positions approximately 180 degrees apart in a substantially vertical plane to thereby render said top and bottom capable of facing in first and second opposite directions, said top providing a highly reflective surface for reflecting light and ultra violet heat energy, and, said bottom providing a highly absorptive surface for absorbing light and heat energy whereby said blind strips can be positioned in one direction to reflect light passing through said window and positioned in a second position to absorb said light.

2. The Venetian blind of claim 1, and:
each slat having a base material to provide a body portion for said blind and said body portion having said top and bottom surfaces coated with paint to thereby provide said reflective and absorptive coating.

3. The Venetian blind of claim 1 and:
each slat having a rigid base material to provide a body portion for said blind and said body also including a second layer of material affixed to said two sides and thereby providing a heat absorbing material to said bottom side and a heat reflecting material to the second, top side.

4. The Venetian blind of claim 1, and:
said top and bottom of each slat provided in the form of a tape and attached to said slat with adhesive.

5. The Venetian blind of claim 1, and said blind strips further including:
said top including a coating of paint in a light color to reflect light, heat and infra red energy and said bottom including a coating of paint having heat and light absorbing properties.

6. A method of controlling the temperature of a room with a window admitting sunlight comprising the steps of:
mounting a Venetian blind in said window and spaced therefrom;
providing said Venetian blind with slats having a reflective side and a heat absorbing side;
mounting an operating mechanism to selectively position the reflective side in a first position facing the window for reflecting light with the heat absorbing side facing the room to absorb heat therein; and moving said slats to a second position or winter setting with the dark side facing the window and reflective side facing the room.

7. The method of controlling room temperature of claim 6 and further including the steps of:
providing said operating mechanism with means for adjusting the length of said blind to make it shorter than said window opening to thereby provide a space at the top and bottom of said window opening thereby creating a thermal air zone between said blind and window to thereby produce air movement from said bottom to top along said Venetian blind.

8. The method of claim 2, and further comprising the steps of:
providing said slats with coatings on opposite sides to reflect and absorb light.
